(19) United States
(12) Patent Application Publication
(10) Pub. No.: US 2016/0003309 A1
(43) Pub. Date: Jan. 7, 2016

(54) HYDRAULIC CONTROL DEVICE AND HYDRAULIC CONTROL METHOD

(71) Applicant: AISIN AW CO., LTD., Anjo-shi, Aichi (JP)

(72) Inventors: Hiroyuki KUTSUBO, Anjo (JP); Masamichi YAMAGUCHI, Anjo (JP); Yoshimitsu HYODO, Nishio (JP); Kenichi TSUCHIDA, Nishio (JP); Kazunori ISHIKAWA, Toyota (JP)

(73) Assignee: AISIN AW CO., LTD., Anjo-shi, Aichi-ken (JP)

(21) Appl. No.: 14/770,325

(22) PCT Filed: Mar. 27, 2014
(86) PCT No.: PCT/JP2014/058932

§ 371 Date: Aug. 25, 2015

(30) Foreign Application Priority Data
Mar. 29, 2013 (JP) 2013-072586

(51) Int. Cl. F16D 48/02; F16H 61/14; F16H 61/00

(52) U.S. Cl. CPC F16D 25/14; F16H 61/0025; F16H 61/14

(57) ABSTRACT

A hydraulic control device that includes a pressure regulating valve capable of regulating a source pressure to generate a control pressure higher than the oil pressure in the circulation oil chamber and supplying the control pressure to the engagement port, wherein when disengaging the lockup clutch, the hydraulic oil is circulated in the circulation oil chamber via the circulation input port and the circulation output port, and part of the hydraulic oil circulated in the circulation oil chamber is supplied to the engagement port, and when engaging the lockup clutch, the supply of the hydraulic oil circulated in the circulation oil chamber to the engagement port is cut off, and the control pressure is supplied to the engagement port.

### BACKGROUND

The present disclosure relates to hydraulic control devices and hydraulic control methods for controlling an oil pressure to be supplied to and discharged from a hydraulic transmission device with a lockup clutch.

A device that is conventionally proposed as this type of hydraulic control is a device for controlling an oil pressure to be supplied to and discharged from a torque converter with a lockup clutch which has a hydraulic transmission chamber (circulation oil chamber) connected to a torque converter inlet-side oil passage and a torque converter outlet-side oil passage, and a lockup clutch oil pressure chamber (engagement oil chamber) to which a lockup clutch oil passage is connected (see, e.g., Japanese Patent Application Publication No. 2011-21695). This device includes a lockup relay valve that switches between the state where a secondary pressure is directly supplied to the torque converter inlet-side oil passage and the state where the secondary pressure is supplied to the torque converter inlet-side oil passage through an orifice, and that switches between the state where a control pressure, namely the secondary pressure regulated by a lockup clutch control valve, is supplied to the lockup clutch oil passage and the state where the supply of the control pressure to the lockup clutch oil passage is cut off. In order to disengage the lockup clutch, the state of the lockup relay valve is switched so that the secondary pressure is supplied to the hydraulic transmission chamber and supply of the control pressure to the lockup clutch oil pressure chamber is cut off. In order to engage the lockup clutch, the state of the lockup relay valve is switched so that the secondary pressure reduced by the orifice is applied to the hydraulic transmission chamber and the control pressure is supplied to the lockup clutch oil pressure chamber. The lockup relay valve and the lockup clutch control valve are driven by a signal pressure that is supplied from an electromagnetic valve.

### SUMMARY

In the above device, however, when the lockup clutch is in the disengaged state, hydraulic oil in the lockup clutch oil pressure chamber is drained via the lockup relay valve, and there is almost no hydraulic oil in the lockup clutch oil pressure chamber. This may cause a delay in rise in oil pressure in the lockup clutch oil pressure chamber when engaging the lockup clutch, and therefore the lockup clutch may not be able to be engaged at a sufficiently high response speed.

According to an exemplary aspect, a hydraulic control device and a hydraulic control method of the present disclosure improves an engagement response of a lockup clutch.

The hydraulic control device and the hydraulic control method of the present disclosure take the following measures.

A hydraulic control device according to the present disclosure is a hydraulic control device for controlling an oil pressure to be supplied to and discharged from a hydraulic transmission device that has a circulation oil chamber having a circulation input port for receiving hydraulic oil and a circulation output port for outputting the hydraulic oil so that the hydraulic oil is circulated in the circulation oil chamber via the circulation input port and the circulation output port, and an engagement oil chamber having an engagement port for receiving and outputting the hydraulic oil, and that includes a lockup clutch that is engaged due to a difference between an oil pressure in the circulation oil chamber and an oil pressure in the engagement oil chamber, including: a pressure regulating valve capable of regulating a source pressure to generate a control pressure higher than the oil pressure in the circulation oil chamber and supplying the control pressure to the engagement port, wherein when disengaging the lockup clutch, the hydraulic oil is circulated in the circulation oil chamber via the circulation input port and the circulation output port, and part of the hydraulic oil circulated in the circulation oil chamber is supplied to the engagement port, and when engaging the lockup clutch, the supply of the hydraulic oil circulated in the circulation oil chamber to the engagement port is cut off, and the control pressure is supplied to the engagement port.

According to the hydraulic control device of the present disclosure, when disengaging the lockup clutch, the hydraulic oil is circulated in the circulation oil chamber via the circulation input port and the circulation output port, and part of the hydraulic oil circulated in the circulation oil chamber is supplied to the engagement port, and when engaging the lockup clutch, the supply of the hydraulic oil circulated in the circulation oil chamber to the engagement port is cut off, and the control pressure higher than the oil pressure in the circulation oil chamber is supplied to the engagement port. The hydraulic oil can therefore be supplied to the engagement oil chamber when the lockup clutch is in the disengaged state. This allows the oil pressure in the engagement oil chamber to rise quickly the next time the lockup clutch is engaged. Engagement response can thus be improved.

The hydraulic control device of the present disclosure may further include: a switch that switches between a first state where the hydraulic oil is circulated in the circulation oil chamber via the circulation input port and the circulation output port and part of the hydraulic oil circulated in the circulation oil chamber is supplied to the engagement port and a second state where the supply of the hydraulic oil circulated in the circulation oil chamber to the engagement port is cut off. When disengaging the lockup clutch, the switch may be switched to the first state to cut off the supply of the control pressure from the pressure regulating valve to the engagement port, and when engaging the lockup clutch, the switch may be switched to the second state to supply the control pressure from the pressure regulating valve to the engagement port. In the hydraulic control device according to this aspect of the present disclosure, the switch may supply the hydraulic oil discharged from the circulation output port to the engagement port when in the first state. In this case, when the lockup clutch is in the disengaged state, the oil pressure in the engagement oil chamber does not become higher than that in the circulation oil chamber, and generation of an engaging force in the lockup clutch can be suppressed. The hydraulic control device according to this aspect of the present disclosure may further include: a control pressure oil passage connected to an output port of the pressure regulating valve; a circulation input oil passage connected to the circulation input port; a circulation output oil passage connected to the circulation output port; a branch oil passage branching off from the circulation output oil passage; and an engagement pressure oil passage connected to the engagement port, wherein the switch may allow the branch oil passage to communicate with the engagement pressure oil passage and cut off communication between the control pressure oil passage and the engagement pressure oil passage when in the first state, and may cut off the communication between the branch oil passage and the engagement pressure oil passage and allow the control pressure oil passage to communicate with the engagement pressure oil passage when in the second state.

A hydraulic control method according to the present disclosure is a hydraulic control method for controlling an oil pressure to be supplied to and discharged from a hydraulic transmission device that has a circulation oil chamber having a circulation input port for receiving hydraulic oil and a circulation output port for outputting the hydraulic oil so that the hydraulic oil is circulated in the circulation oil chamber via the circulation input port and the circulation output port, and an engagement oil chamber having an engagement port for receiving and outputting the hydraulic oil, and that includes a lockup clutch that is engaged due to a difference between an oil pressure in the circulation oil chamber and an oil pressure in the engagement oil chamber, including: when disengaging the lockup clutch, circulating the hydraulic oil in the circulation oil chamber via the circulation input port and the circulation output port and supplying part of the hydraulic oil circulated in the circulation oil chamber to the engagement port, and when engaging the lockup clutch, cutting off the supply of the hydraulic oil circulated in the circulation oil chamber to the engagement port and supplying a control pressure higher than the oil pressure in the circulation oil chamber to the engagement port.

According to the hydraulic control method of the present disclosure, when disengaging the lockup clutch, the hydraulic oil is circulated in the circulation oil chamber via the circulation input port and the circulation output port, and part of the hydraulic oil circulated in the circulation oil chamber is supplied to the engagement port, and when engaging the lockup clutch, the supply of the hydraulic oil circulated in the circulation oil chamber to the engagement port is cut off, and the control pressure higher than the oil pressure in the circulation oil chamber is supplied to the engagement port. The hydraulic oil can therefore be supplied to the engagement oil chamber when the lockup clutch is in the disengaged state. This allows the oil pressure in the engagement oil chamber to rise quickly the next time the lockup clutch is engaged. Engagement response can thus be improved.

### BRIEF DESCRIPTION OF THE DRAWINGS

FIG. 1 is a configuration diagram schematically showing the configuration of an automobile.

FIG. 2 is an illustration showing an operation table of a speed change mechanism.

FIG. 3 is a configuration diagram schematically showing the configuration of a hydraulic control device according to an embodiment of the present disclosure.

FIG. 4 is an illustration illustrating operation of the hydraulic control device of the embodiment in the case where a lockup clutch is in a disengaged state.

FIG. 5 is an illustration illustrating operation of the hydraulic control device of the embodiment in the case where the lockup clutch is in an engaged state.

FIG. 6 is an illustration showing how an engine rotational speed, a turbine rotational speed, a circulation input pressure, a circulation output pressure, and a lockup-on pressure change with time when engaging the lockup clutch by using a hydraulic control device of a comparative example.

FIG. 7 is an illustration showing how the engine rotational speed, the turbine rotational speed, the circulation input pressure, the circulation output pressure, and the lockup-on pressure change with time when engaging the lockup clutch by using the hydraulic control device of the embodiment.

FIG. 8 is an illustration illustrating operation of a hydraulic control device of a modification in the case where the lockup clutch is in the disengaged state.

FIG. 9 is an illustration illustrating operation of the hydraulic control device of the modification in the case where the lockup clutch is in the engaged state.

### DETAILED DESCRIPTION OF THE EMBODIMENTS

A mode for carrying out the present disclosure will be described below by using an embodiment with reference to the accompanying drawings.

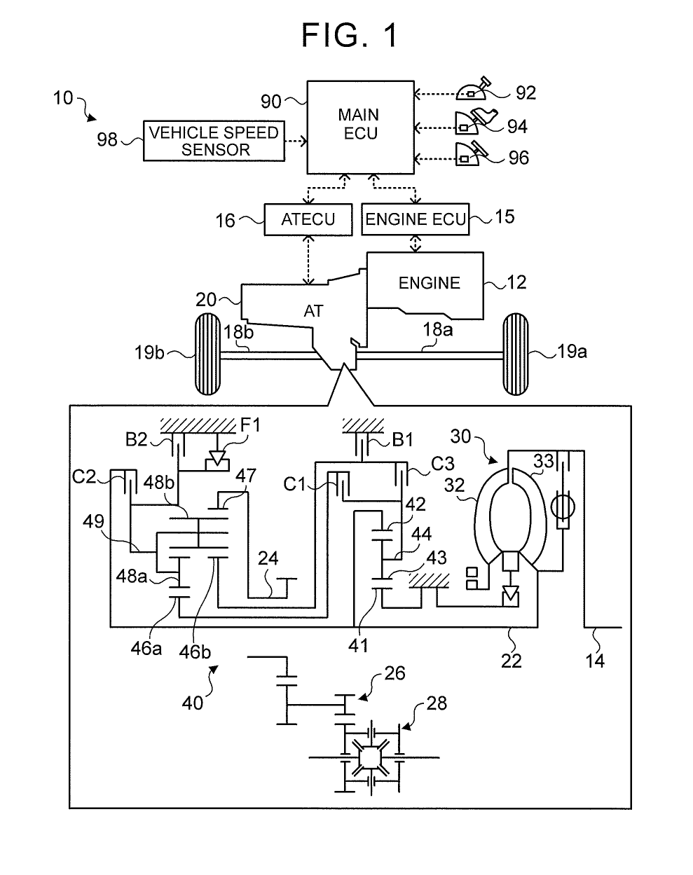

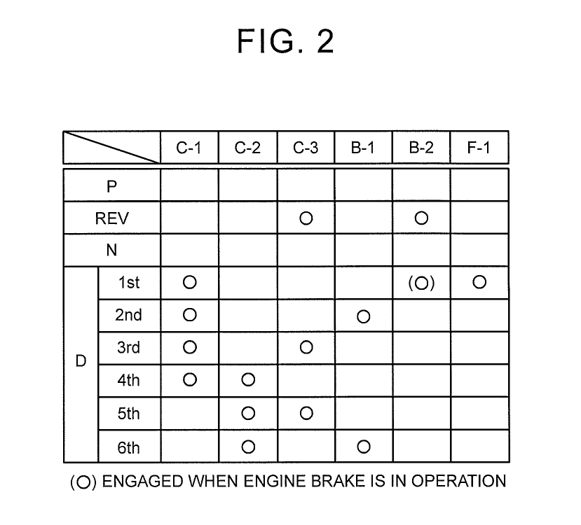

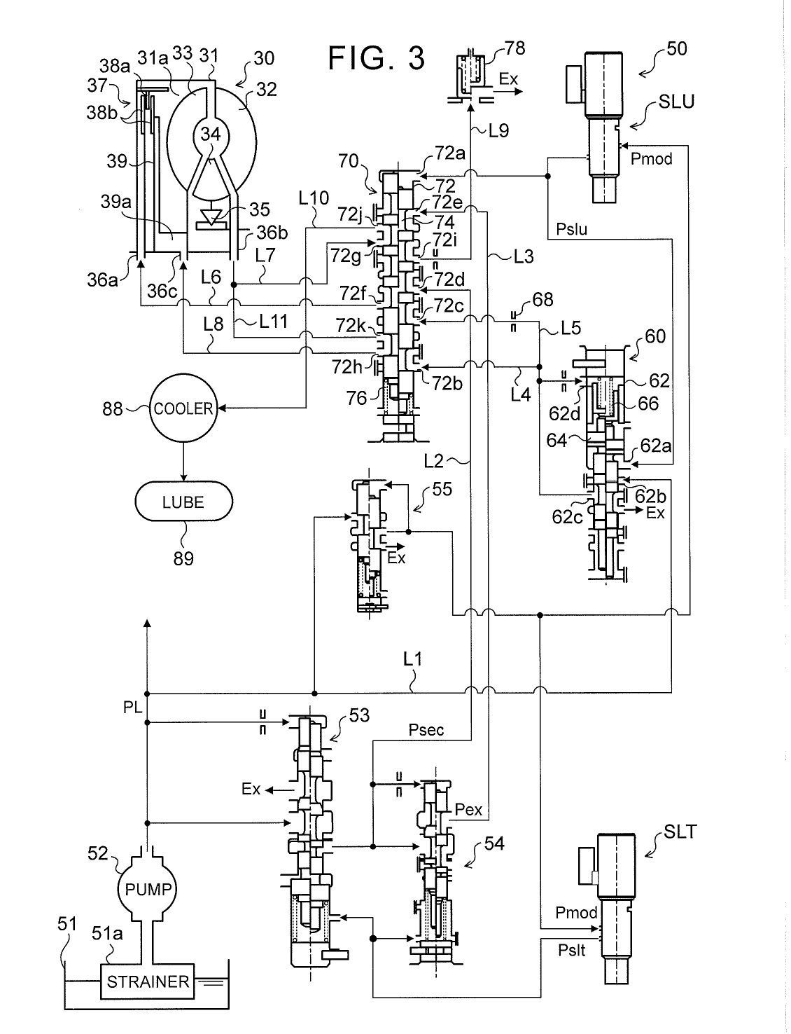

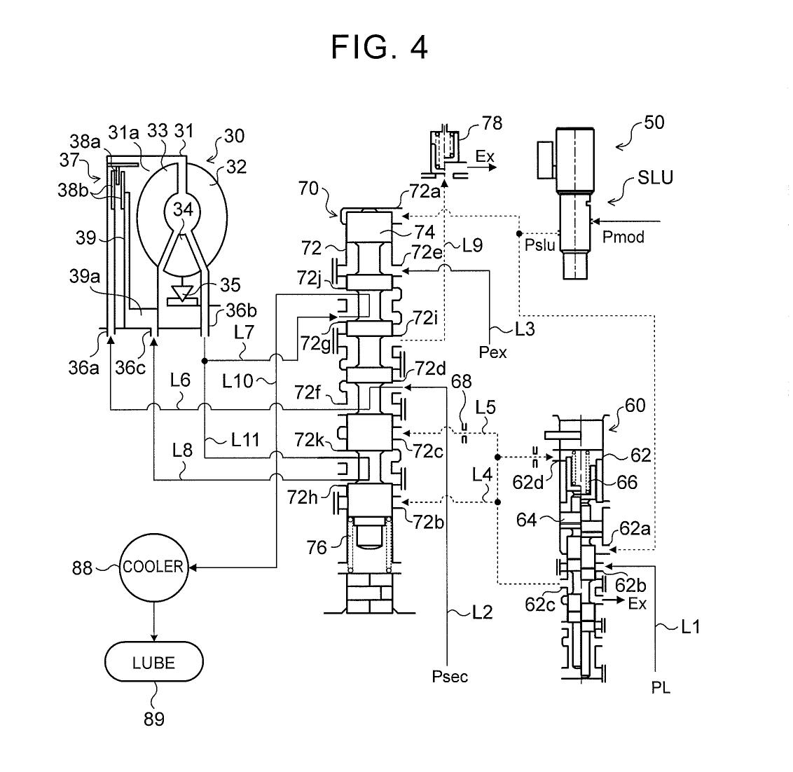

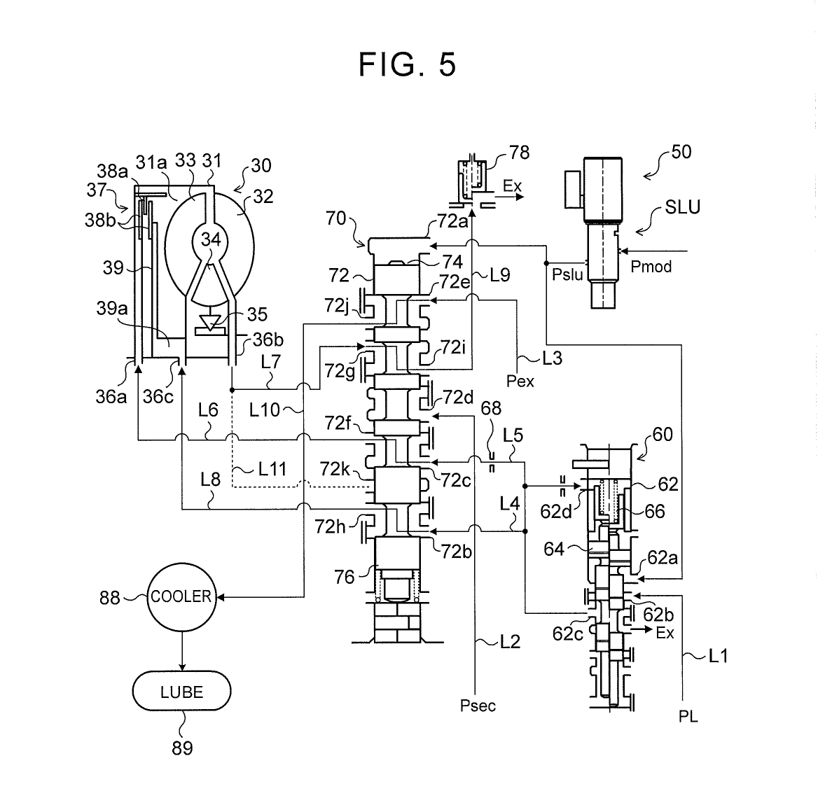

FIG. 1 is a configuration diagram schematically showing the configuration of an automobile 10. FIG. 2 is an illustration showing an operation table of a speed change mechanism 40. FIG. 3 is a configuration diagram schematically showing the configuration of a hydraulic control device 50 according to an embodiment of the present disclosure. FIG. 4 is an illustration illustrating operation of the hydraulic control device 50 of the embodiment in the case where a lockup clutch 37 is in a disengaged state. FIG. 5 is an illustration illustrating operation of the hydraulic control device 50 of the embodiment in the case where the lockup clutch 37 is in an engaged state.

As shown in FIG. 1, the automobile 10 includes: an engine 12 as an internal combustion engine that outputs power by explosive combustion of hydrocarbon fuel such as gasoline or light oil; an engine electronic control unit (engine ECU) 15 that controls operation of the engine 12; an automatic transmission 20 that is connected to a crankshaft 14 of the engine 12 and connected to axles 18a, 18b of left and right wheels 19a, 19b to transmit the power from the engine 12 to the axles 18a, 18b; an automatic transmission electronic control unit (ATECU) 16 that controls the automatic transmission 20; and a main electronic control unit (main ECU) 90 that controls the entire vehicle. The main ECU 90 receives via input ports a shift position SP from a shift position sensor 92 that detects the operation position of a shift lever, an accelerator operation amount Acc from an accelerator pedal position sensor 94 that detects the depression amount of an accelerator pedal, a brake switch signal BSW from a brake switch 96 that detects depression of a brake pedal, a vehicle speed V from a vehicle speed sensor 98, etc. The main ECU 90 communicates with the engine ECU 15 and the ATECU 16 via communication ports to send and receive various control signals and data to and from the engine ECU 15 and the ATECU 16.

As shown in FIG. 1, the automatic transmission 20 includes: a torque converter 30 with a lockup clutch which is formed by an input-side pump impeller 32 connected to the crankshaft 14 of the engine 12 and an output-side turbine runner 33; the stepped speed change mechanism 40 that has an input shaft 22 connected to the turbine runner 33 of the torque converter 30 and an output shaft 24 connected to the axles 18a, 18b via a gear mechanism 26 and a differential gear 28, and that shifts power received by the input shaft 22 to output the shifted power to the output shaft 24; and the hydraulic control device 50 of the present embodiment (see FIG. 3) which controls the torque converter 30 and the speed change mechanism 40.

The speed change mechanism 40 is configured as a six-speed stepped speed change mechanism, and includes a single-pinion type planetary gear mechanism, a Ravigneaux type planetary gear mechanism, three clutches C1, C2, C3, two brakes B1, B2, and a one-way clutch F1. The single-pinion type planetary gear mechanism includes a sun gear 41 as an external gear, a ring gear 42 as an internal gear placed on a concentric circle with the sun gear 41, a plurality of pinion gears 43 meshing with the sun gear 41 and meshing with the ring gear 42, and a carrier 44 holding the plurality of pinion gears 43 such that the pinion gears 43 can rotate and revolve. The sun gear 41 is fixed to a case, and the ring gear 42 is connected to the input shaft 22. The Ravigneaux type planetary gear mechanism includes two sun gears 46a, 46b as external gears, a ring gear 47 as an internal gear, a plurality of short pinion gears 48a meshing with the sun gear 46a, a plurality of long pinion gears 48b meshing with the sun gear 46b and the plurality of short pinion gears 48a and meshing with the ring gear 47, and a carrier 49 coupling the plurality of short pinion gears 48a and the plurality of long pinion gears 48b and holding the plurality of short pinion gears 48a and the plurality of long pinion gears 48b such that the plurality of short pinion gears 48a and the plurality of long pinion gears 48b can rotate and revolve. The sun gear 46a is connected to the carrier 44 of the single-pinion type planetary gear mechanism via the clutch C1, the sun gear 46b is connected to the carrier 44 via the clutch C3 and is connected to the case via the brake B1, the ring gear 47 is connected to the output shaft 24, and the carrier 49 is connected to the input shaft 22 via the clutch C2. The carrier 49 is connected to the case via the one-way clutch F1, and is also connected to the case via the brake B2 provided in parallel with the one-way clutch F1.

As shown in FIG. 2, the speed change mechanism 40 can switch among first to sixth forward speeds, a reverse speed, and a neutral state by combination of the on/off states of the clutches C1 to C3 and the on/off states of the brakes B1, B2. The reverse speed can be attained by turning on the clutch C3 and the brake B2 and turning off the clutches C1, C2 and the brake B1. The first forward speed can be attained by turning on the clutch C1 and turning off the clutches C2, C3 and the brakes B1, B2. At the first forward speed, the brake B2 is turned on when engine brake is in operation. The second forward speed can be attained by turning on the clutch C1 and the brake B1 and turning off the clutches C2, C3 and the brake B2. The third forward speed can be attained by turning on the clutches C1, C3 and turning off the clutch C2 and the brakes B1, B2. The fourth forward speed can be attained by turning on the clutches C1, C2 and turning off the clutch C3 and the brakes B1, B2. The fifth forward speed can be attained by turning on the clutches C2, C3 and turning off the clutch C1 and the brakes B1, B2. The sixth forward speed can be attained by turning on the clutch C2 and the brake B1 and turning off the clutches C1, C3 and the brake B2. The neutral state can be attained by turning off all of the clutches C1 to C3 and the brakes B1, B2.

The torque converter 30 is configured as a hydraulic torque converter with a lockup clutch. As shown in FIG. 3, the torque converter 30 includes: the pump impeller 32 that is connected to the crankshaft 14 of the engine 12 via a converter cover 31; the turbine runner 33 that is placed so as to face the pump impeller 32 and connected to the input shaft 22 of the automatic transmission 20; a stator 34 that is placed between the pump impeller 32 and the turbine runner 33 and adjusts the flow of hydraulic oil from the turbine runner 33 to the pump impeller 32; a one-way clutch 35 that limits rotation of the stator 34 to one direction; and the lockup clutch 37 that mechanically couples the pump impeller 32 (converter cover 31) and the turbine runner 33. The torque converter 30 transfers torque by converting engine torque into flow of hydraulic oil by the pump impeller 32 and converting this flow of hydraulic oil into torque on the input shaft 22 of the automatic transmission 20 by the turbine runner 33. The torque converter 30 functions as a torque amplifier by the operation of the stator 34 when the rotational speed difference between the pump impeller 32 and the turbine runner 33 is large, and functions merely as a fluid coupling when the rotational speed difference between the pump impeller 32 and the turbine runner 33 is small. A converter oil chamber 31a surrounded by the converter cover 31 and the pump impeller 32 of the torque converter 30 has a circulation input port 36a for introducing hydraulic oil into the converter oil chamber 31a and a circulation output port 36b for discharging hydraulic oil from the converter oil chamber 31a, in order to circulate the hydraulic oil in the converter oil chamber 31a.

As shown in FIG. 3, the lockup clutch 37 is configured as a multi-plate clutch capable of performing a lockup operation of coupling the pump impeller 32 and turbine runner 33 and capable of cancelling the lockup. The lockup clutch 37 includes: a clutch plate 38a slidably supported by a clutch hub fixed to the converter cover 31; a clutch plate 38b slidably supported by a clutch hub connected to the turbine runner 33; and a clutch piston 39 movably placed in the converter cover 31 so as to press the clutch plates 38a, 38b. A lockup oil chamber 39a is defined on the back side of the clutch piston 39. The clutch piston 39 is moved due to the difference between the pressure of hydraulic oil introduced into the lockup oil chamber 39a and the pressure of hydraulic oil in the converter oil chamber 31a. The clutch plates 38a, 38b are thus subjected to a compressive pressure, whereby the lockup operation of coupling the pump impeller 32 and the turbine runner 33 is performed. The lockup oil chamber 39a has a lockup port 36c for introducing and discharging hydraulic oil to and from the lockup oil chamber 39a.

As shown in FIG. 3, the hydraulic control device 50 of the embodiment includes: a mechanical oil pump 52 that pumps hydraulic oil from an oil pan 51 to a line pressure oil passage L1 via a strainer 51a by the power from the engine; a primary regulator valve 53 that regulates the pressure of the hydraulic oil pumped to the line pressure oil passage L1 to generate a line pressure PL, and outputs excess hydraulic oil associated with generation of the line pressure PL to a secondary pressure oil passage L2; a secondary regulator valve 54 that regulates the pressure of the hydraulic oil in the secondary pressure oil passage L2 to generate a secondary pressure Psec, and outputs excess hydraulic oil associated with generation of the secondary pressure Psec to a secondary discharge pressure oil passage L3; a modulator valve 55 that reduces the line pressure PL to generate a modulator pressure Pmod; a linear solenoid valve SLT that regulates the modulator pressure Pmod from the modulator valve 55 to generate a signal pressure Pslt for actuating the primary regulator valve 53 and the secondary regulator valve 54; a lockup control valve 60 that generates from the line pressure PL in the line pressure oil passage L1 a control pressure Pcl for engaging the lockup clutch 37 and outputs the control pressure Pcl; a lockup relay valve 70 that switches the path for hydraulic oil to be supplied to and discharged from the torque converter 30; and a linear solenoid valve SLU that regulates the modulator pressure Pmod to generate a signal pressure Pslu for actuating the lockup control valve 60 and the lockup relay valve 70. The linear solenoid valve SLT and the linear solenoid valve SLU are controlled by the ATECU 16. Although not shown in detail in the figure, the ATECU 16 is formed as a microprocessor mainly composed of a CPU, and includes, in addition to the CPU, a ROM that stores a processing program, a RAM that temporarily stores data, input and output ports, a communication port, etc. The ATECU 16 communicates with the main ECU 90 to send and receive control signals and data to and from the main ECU 90.

The line pressure PL is individually supplied to the clutches C1 to C3 and the brakes B1, B2 via corresponding linear solenoid valves (not shown). Each of the linear solenoid valves regulates the line pressure PL so that a corresponding one of the clutches and the brakes has torque capacity high enough to transfer the input torque from the input shaft 22 to the output shaft 24 of the automatic transmission 20, and supplies the regulated line pressure PL to the corresponding clutch or brake.

The lockup control valve 60 is a pressure regulating valve that is actuated by the signal pressure Pslu from the linear solenoid valve SLU. As shown in FIG. 3, the lockup control valve 60 includes a sleeve 62 having various ports, a spool 64 that allows corresponding ones of the ports to communicate with each other and cuts off the communication therebetween, and a spring 66 that biases the spool 64 downward in the figure. As the various ports, the sleeve 62 has: a signal pressure input port 62a that receives the signal pressure Pslu from the linear solenoid valve SLU; an input port 62b that is connected to the line pressure oil passage L1 to receive the line pressure PL; an output port 62c that regulates the line pressure PL to output the regulated line pressure, namely the control pressure Pcl to control pressure oil passages L4, L5; and a feedback port 62d that receives the output pressure from the output port 62c as a feedback pressure for biasing the spool 64 downward in the figure. The signal pressure input port 62a is formed at a position between two lands of the spool 64 which have different outer diameters. The signal pressure that is applied to the signal pressure input port 62a serves as a force that biases the spool 64 upward in the figure, due to the difference in area (difference in outer diameter) between the pressure receiving surfaces of the two lands, namely the upper land with a larger outer diameter and the lower land with a smaller outer diameter in the figure. The spool 64 is thus biased upward in the figure by the signal pressure Pslu applied to the signal pressure input port 62a, and is biased downward in the figure by the spring force of the spring 66 and the feedback pressure applied to the feedback port 62d. The lockup control valve 60 regulates the line pressure PL so that the higher the signal pressure Pslu is, the more the spool 64 is moved upward in the figure to increase the communication area between the input port 62b and the output port 62c to increase the control pressure Pcl.

The control pressure oil passage L5 has an orifice 68. The control pressure Pcl output from the output port 62c of the lockup control valve 60 is reduced by the orifice 68 and supplied to the lockup relay valve 70 (input port 72c).

The lockup relay valve 70 is a switch valve that is actuated by the signal pressure Pslu from the linear solenoid valve SLU to switch the path for supplying and discharging an oil pressure. As shown in FIG. 3, the lockup relay valve 70 includes a sleeve 72 having various ports, a spool 74 that allows corresponding ones of the ports to communicate with each other and cuts off the communication therebetween, and a spring 76 that biases the spool 74 upward in the figure. As the various ports, the sleeve 72 has: a signal pressure input port 72a that receives the signal pressure Pslu from the linear solenoid valve SLU; an input port 72b that is connected to the output port 62c of the lockup control valve 60 via the control pressure oil passage L4 to receive the control pressure Pcl from the output port 62c; an input port 72c that is connected to the output port 62c of the lockup control valve 60 via the control pressure oil passage L5 to receive the control pressure Pcl output from the output port 62c and reduced by the orifice 68; an input port 72d that is connected to the secondary pressure oil passage L2 to receive the secondary pressure Psec; an input port 72e that is connected to the secondary discharge pressure oil passage L3 to receive a secondary discharge pressure Pex; an output port 72f that is connected to the circulation input port 36a of the torque converter 30 via a circulation input oil passage L6; an input port 72g that is connected to the circulation output port 36b of the torque converter 30 via a circulation output oil passage L7; an output port 72h that is connected to the lockup port 36c of the torque converter 30 via a lockup oil passage L8; a relief port 72i that is connected to a relief oil passage L9 having a relief valve 78 attached thereto; a lubrication port 72j that is connected to a lubrication oil passage L10 having a cooler (COOLER) 88 attached thereto; and an input port 72k that is connected to a branch oil passage L11 that branches off from the circulation output oil passage L7. A target 89 to be lubricated is connected to the subsequent stage of the cooler 88 so that hydraulic oil output to the lubrication oil passage L10 is supplied to the target 89 after being cooled by the cooler 88.

When the signal pressure Pslu is not applied from the linear solenoid SLU to the signal pressure input port 72a of the lockup relay valve 70, the spool 74 is moved upward in FIG. 3 by the biasing force of the spring 76. Accordingly, communication between the input port 72b and the output port 72h is cut off, communication between the input port 72c and the output port 72f is cut off, the input port 72d communicates with the output port 72f, communication between the input port 72e and the lubrication port 72j is cut off, the input port 72g communicates with the lubrication port 72j, communication between the input port 72g and the relief port 72i is cut off, and the input port 72k communicates with the output port 72h. The secondary pressure oil passage L2 to which the input port 72d is connected thus communicates with the circulation input oil passage L6 to which the output port 72f is connected, and the circulation output oil passage L7 to which the input port 72g is connected communicates with the lubrication oil passage L10 to which the lubrication port 72j is connected. Since the circulation output oil passage L7 is also connected to the input port 72k via the branch oil passage L11, the circulation output oil passage L7 also communicates with the lockup oil passage L8 to which the output port 72h is connected.

On the other hand, when the signal pressure Pslu is applied from the linear solenoid valve SLU to the signal pressure input port 72a, the spool 74 is subjected to a pressing force that overcomes the biasing force of the spring 76, so that the spool 74 is moved downward in FIG. 3. Accordingly, the input port 72b communicates with the output port 72h, the input port 72c communicates with the output port 72f, communication between the input port 72d and the output port 72f is cut off, the input port 72e communicates with the lubrication port 72j, communication between the input port 72g and the lubrication port 72j is cut off, the input port 72g communicates with the relief port 72i, and communication between the input port 72k and the output port 72h is cut off. The control pressure oil passage L4 to which the input port 72b is connected communicates with the lockup oil passage L8 to which the output port 72h is connected, and the control pressure oil passage L5 to which the input port 72c is connected communicates with the circulation input oil passage L6 to which the output port 72f is connected. Moreover, the circulation output oil passage L7 to which the input port 72g is connected communicates with the relief oil passage L9 to which the relief port 72i is connected, and the secondary discharge pressure oil passage L3 to which the input port 72e is connected communicates with the lubrication oil passage L10 to which the lubrication port 72j is connected.

Operation of the hydraulic control device 50 of the embodiment having the above configuration will be described below. First, operation in the case of disengaging the lockup clutch 37 will be described. The lockup clutch 37 can be disengaged by turning off the linear solenoid valve SLU to bring the spool 74 of the lockup relay valve 70 into the state shown in FIG. 4. In this state, the secondary pressure oil passage L2 communicates with the circulation input oil passage L6, and the circulation output oil passage L7 communicates with the lubrication oil passage L10, as described above. Accordingly, hydraulic oil pumped due to the secondary pressure Psec is supplied to the converter oil chamber 31a of the torque converter 30 via the circulation input oil passage L6 and is fed from the converter oil chamber 31a to the cooler 88 via the circulation output oil passage L7 and the lubrication oil passage L10. The hydraulic oil is cooled by the cooler 88 and is then supplied to the target 89 to be lubricated. That is, when the lockup clutch 37 is in the disengaged state, the hydraulic oil pumped due to the secondary pressure Psec is supplied to the converter oil chamber 31a, and the hydraulic oil having passed through the converter oil chamber 31a is cooled by the cooler 88 and then supplied to the target 89 as lubricating oil. Since the circulation output oil passage L7 also communicates with the lockup oil passage L8 via the branch oil passage L11, part of the hydraulic oil output to the circulation output oil passage L7 is supplied to the lockup oil chamber 39a via the branch oil passage L11 and the lockup oil passage L8. In this state, the lockup oil chamber 39a and the lockup oil passage L8 are therefore filled with the hydraulic oil. The hydraulic oil that is supplied to the lockup oil chamber 39a is the hydraulic oil on the downstream side which has passed through the converter oil chamber 31a, and the oil pressure in the lockup oil chamber 39a is not higher than that in the converter oil chamber 31a. Accordingly, the lockup clutch 37 does not generate an engaging force.

Next, operation in the case of engaging the lockup clutch 37 will be described. The lockup clutch 37 is engaged by turning on the linear solenoid valve SLU to bring the spool 74 of the lockup relay valve 70 into the state shown in FIG. 5 and controlling the lockup control valve 60 by adjusting the signal pressure Pslu to be output from the linear solenoid valve SLU so that the difference between the oil pressure in the lockup oil chamber 39a and the oil pressure in the converter oil chamber 31a becomes equal to a target oil pressure. In this state, the control pressure oil passage L4 communicates with the lockup oil passage L8, the control pressure oil passage L5 communicates with the circulation input oil passage L6, and the circulation output oil passage L7 communicates with the relief oil passage L9, as described above. Accordingly, the control pressure Pcl output from the output port 62c of the lockup control valve 60 is supplied to the lockup oil chamber 39a via the control pressure oil passage L4 and the lockup oil passage L8 as an engagement pressure for engaging the lockup clutch 37, and hydraulic oil pumped due to the oil pressure output from the output port 62c of the lockup control valve 60 and reduced by the orifice 68 is supplied to the converter oil chamber 31a via the control pressure oil passage L5 and the circulation input oil passage L6, and the hydraulic oil having passed through the converter oil chamber 31a is drained via the circulation output oil passage L7, the relief oil passage L9, and the relief valve 78. That is, since the control pressure Pa is applied to the lockup oil chamber 39a, and the control pressure Pa reduced by the orifice 68 is applied to the converter oil chamber 31a, there is a difference in oil pressure between the lockup oil chamber 39a and the converter oil chamber 31a, whereby the lockup clutch 37 can be engaged. Since this difference in oil pressure increases with an increase in control pressure Pcl and decreases with a decrease in control pressure Pcl, the engagement pressure for the lockup clutch 37 can be controlled by actuating the lockup control valve 60 with the signal pressure from the linear solenoid valve SLU and regulating the control pressure Pcl. As described above, when the lockup clutch 37 is in the disengaged state, part of the hydraulic oil circulated in the converter oil chamber 31a and output to the circulation output oil passage L7 is supplied to the lockup oil chamber 39a via the lockup oil passage L8, and the lockup oil chamber 39a and the lockup oil passage L8 are therefore filled with the hydraulic oil. This allows the oil pressure in the lockup oil chamber 39a to rise quickly when the control pressure Pcl is applied to the lockup oil chamber 39a, whereby the lockup clutch 37 can be smoothly engaged. When the lockup clutch 37 is in the engaged state, the secondary discharge pressure oil passage L3 communicates with the lubrication oil passage L10. Accordingly, hydraulic oil pumped due to the secondary discharge pressure Pex can be cooled by the cooler 88 and supplied to the target 89 as lubricating oil.

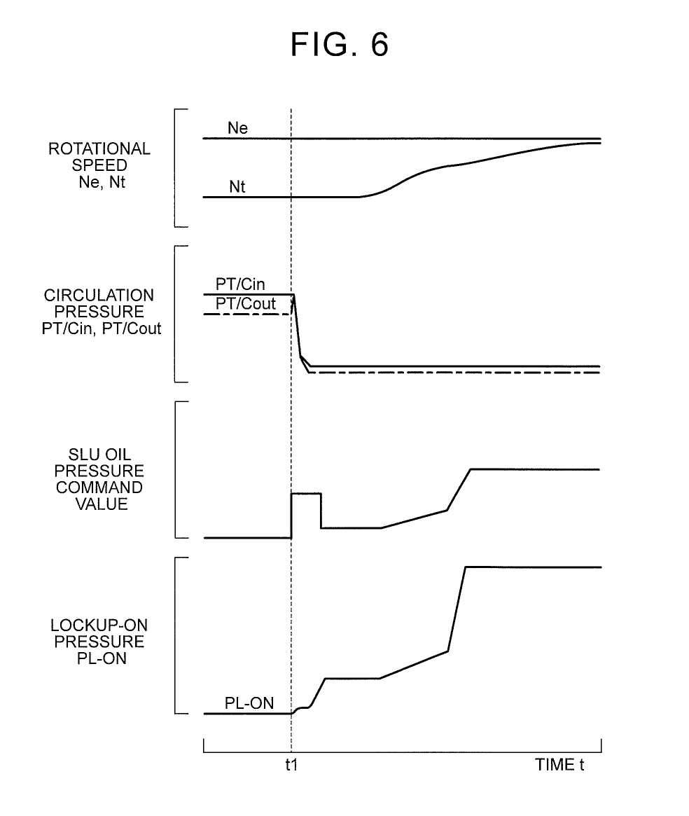

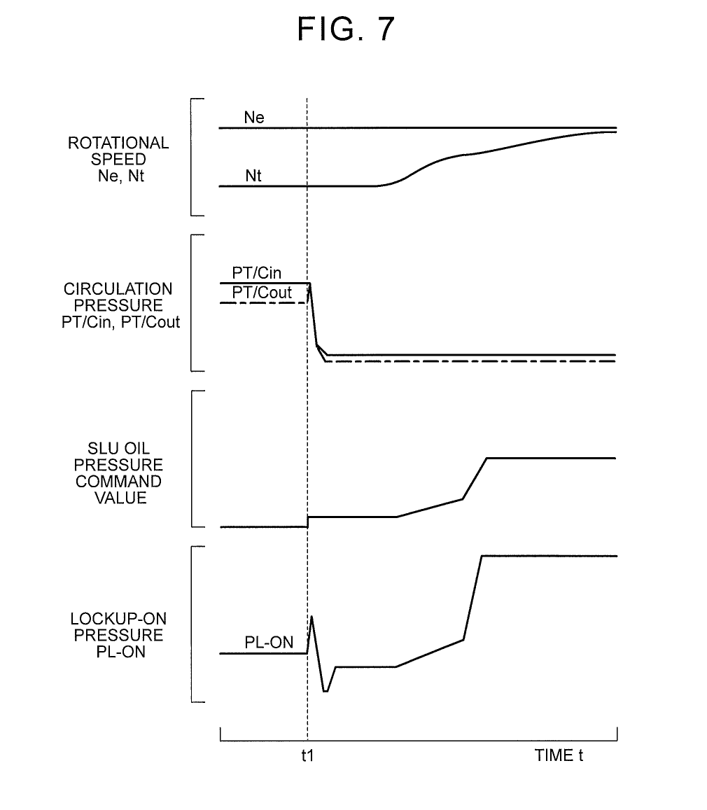

FIG. 6 is an illustration showing how an engine rotational speed Ne, a turbine rotational speed Nt, a circulation input pressure PT/Cin, a circulation output pressure PT/Cout, and a lockup-on pressure PL-ON change with time when engaging the lockup clutch 37 by using a hydraulic control device of a comparative example. FIG. 7 is an illustration showing how the engine rotational speed Ne, the turbine rotational speed Nt, the circulation input pressure PT/Cin, the circulation output pressure PT/Cout, and the lockup-on pressure PL-ON change with time when engaging the lockup clutch 37 by using the hydraulic control device 50 of the embodiment. In the hydraulic control device of the comparative example, the branch oil passage L11 in the hydraulic control device 50 of the embodiment is omitted, and the relief oil passage L9 instead of the branch oil passage L11 is connected to the input port 72k of the lockup relay valve 70. The turbine rotational speed Nt represents the rotational seed of the input shaft 22, the circulation input pressure PT/Cin represents the input pressure that is applied to the circulation input port 36a, the circulation output pressure PT/Cout represents the output pressure that is output from the circulation output port 36b, and the lockup-on pressure PL-ON represents the oil pressure in the lockup oil chamber 39a. In the comparative example, when the lockup clutch 37 is in the disengaged state, hydraulic oil in the lockup oil chamber 39a and the lockup oil passage L8 has been relieved via the relief oil passage L9. As shown in FIG. 6, in response to a command to engage the lockup clutch 37 at time t1, control of temporarily significantly increasing an oil pressure command for the linear solenoid valve SLU, which is called “fast fill control,” is therefore executed to cause the oil pressure in the lockup oil chamber 39a (lockup-on pressure PL-ON) to rise, and then the oil pressure command is kept low and is gradually increased to engage the lockup clutch 37. In the embodiment, however, when the lockup clutch 37 is in the disengaged state, part of the hydraulic oil circulated in the converter oil chamber 31a and output to the circulation output oil passage L7 is supplied to the lockup oil passage L8 and the lockup oil chamber 39a via the branch oil passage L11, and the lockup oil chamber 39a and the lockup oil passage L8 are therefore filled with the hydraulic oil. As shown in FIG. 7, in response to a command to engage the lockup clutch 37 at time t1, the lockup-on pressure PL-ON therefore quickly rises according to an oil pressure command for the linear solenoid valve SLU even if this oil pressure command is relatively low. Accordingly, the fast fill control of temporarily significantly increasing the oil pressure command for the linear solenoid valve SLU is not required in the embodiment. The lockup clutch 37 can therefore be smoothly engaged while reducing power consumption of the linear solenoid valve SLU.

In the hydraulic control device 50 of the above embodiment, the circulation output oil passage L7 is connected to the input port 72k of the lockup relay valve 70 via the branch oil passage L11. The input port 72k is allowed to communicate with the output port 72h connected to the lockup oil passage L8 when the lockup clutch 37 is disengaged, and the communication between the input port 72k and the output port 72h is cut off when the lockup clutch 38 is disengaged. Accordingly, when the lockup clutch 37 is in the disengaged state, part of the hydraulic oil circulated in the converter oil chamber 31a and output to the circulation output oil passage L7 can be supplied to the lockup oil passage L8 and the lockup oil chamber 39a via the branch oil passage L11, whereby the lockup oil chamber 39a and the lockup oil passage L8 can be filled with the hydraulic oil. This allows the oil pressure in the lockup oil chamber 39a to rise quickly without executing the fast fill control of temporarily rapidly increasing the oil pressure command for the linear solenoid valve SLU the next time the lockup clutch 37 is engaged. As a result, the lockup clutch 37 can be smoothly engaged while reducing power consumption of the linear solenoid valve SLU.

In the embodiment, when the lockup clutch 37 is in the disengaged state, part of the hydraulic oil circulated in the converter oil chamber 31a and output to the circulation output oil passage L7 is supplied to the lockup oil chamber 39a. However, the present disclosure is not limited to this. Part of the hydraulic oil that is passing through the circulation input oil passage L6 and that has not been circulated in the converter oil chamber 31a may be supplied to the lockup oil chamber 39a. In this case, for example, the configuration in which the circulation input oil passage L6 is connected to the input port 72k of the lockup relay valve 70 via a branch oil passage and an orifice is formed in this branch oil passage is used instead of the configuration in which the circulation output oil passage L7 is connected to the input port 72k of the lockup relay valve 70 via the branch oil passage L11. In this case as well, since the oil pressure in the lockup oil chamber 39a can be made lower than that in the converter oil chamber 31a, the lockup oil chamber 39a can be filled with hydraulic oil without causing the lockup clutch 37 to generate an engaging force.

In the embodiment, when the lockup clutch 37 is in the engaged state, the line pressure PL is used as a source pressure of the control pressure Pcl that is supplied to the lockup oil chamber 39a. However, the present disclosure is not limited to this. The secondary pressure Psec may be used as a source pressure of the control pressure Pcl.

In the embodiment, when the lockup clutch 37 is in the engaged state, the control pressure Pcl is supplied to the lockup oil chamber 39a, and the control pressure Pcl reduced by the orifice 68 is supplied to the converter oil chamber 31a as a circulation pressure. However, the present disclosure is not limited to this. For example, the control pressure Pcl may be supplied to the lockup oil chamber 39a, and the secondary pressure Psec may be supplied to the converter oil chamber 31a as a circulation pressure. Alternatively, the control pressure Pcl may be supplied to the lockup oil chamber 39a, and the secondary pressure Psec reduced by an orifice may be supplied to the converter oil chamber 31a as a circulation pressure.

In the embodiment, when the lockup clutch 37 is in the disengaged state, the secondary pressure Psec is used as a source pressure of the circulation pressure that is circulated in the converter oil chamber 31a. However, the present disclosure is not limited to this. For example, the secondary pressure Psec reduced by an orifice may be used, or the line pressure PL reduced by an orifice may be used.

In the embodiment, both the lockup control valve 60 and the lockup relay valve 70 are controlled by the signal pressure Pslu from the single linear solenoid SLU. However, the present disclosure is not limited to this. The lockup control valve 60 and the lockup relay valve 70 may be individually controlled by using signal pressures from separate linear solenoids.

In the embodiment, the single lockup relay valve 70 is used to switch the path for supplying and discharging an oil pressure to and from the circulation input oil passage L6, the circulation output oil passage L7, and the lockup oil passage L8 for the torque converter 30. However, a plurality of relay valves may be used to switch the path.

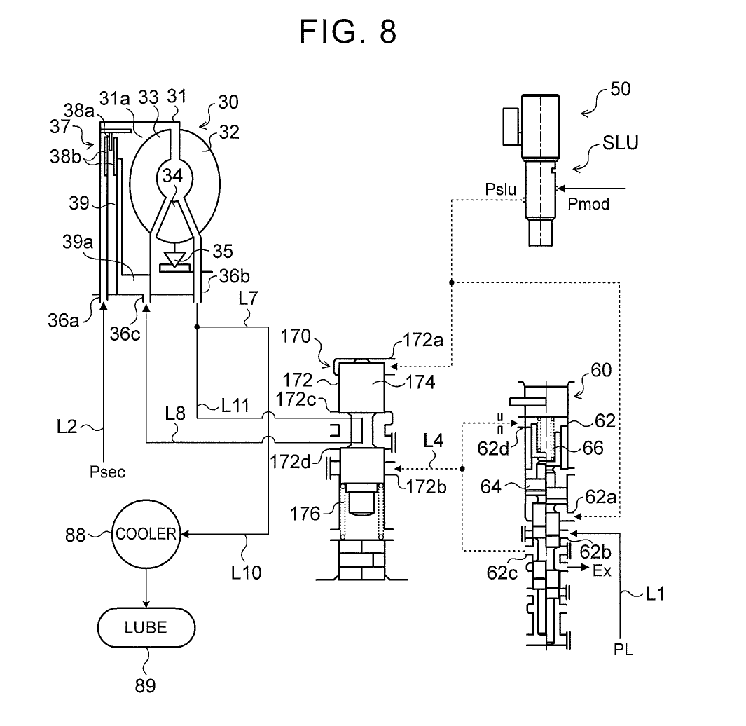

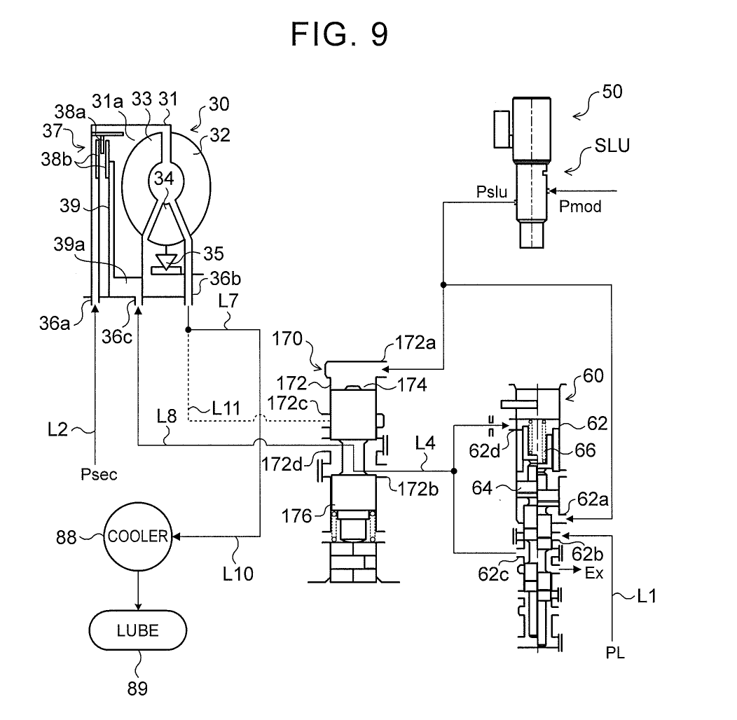

In the embodiment, when the lockup clutch 37 is in the engaged state, the line pressure reduced by the orifice 68 is used to supply hydraulic oil to the converter oil chamber 31a (circulation input port 36a). However, the present disclosure is not limited to this. Even when the lockup clutch 37 is in the engaged state, the secondary pressure Psec may be used to supply hydraulic oil to the converter oil chamber 31a (circulation input port 36a). A hydraulic control device 150 of a modification in this case is shown in FIGS. 8 and 9. FIG. 8 shows the state of the hydraulic control device 150 in the case where the lockup clutch 37 is in the disengaged state (lockup off). FIG. 9 shows the state of the hydraulic control device 150 in the case where the lockup clutch 37 is in the engaged state (lockup on). The hydraulic control device 150 of the modification is mainly different from the hydraulic control device 50 of the embodiment in that the secondary pressure oil passage L2 is directly connected to the circulation input port 36a, in that the hydraulic control device 150 includes a lockup relay valve 170 instead of the lockup relay valve 70, and in that the circulation output oil passage L7 is directly connected to the lubrication oil passage L10. As shown in FIGS. 8 and 9, the lockup relay valve 170 of the modification is a switch valve including: a sleeve 172 having a signal pressure input port 172a for receiving the signal pressure Pslu from the linear solenoid valve SLU, two input ports 172b, 172c, and an output port 172d; a spool 174 that allows corresponding ones of the input and output ports to communicate with each other and cuts off the communication therebetween; and a spring 176 that biases the spool 174 in the opposite direction from the direction in which the signal pressure Pslu is applied. The control pressure oil passage L4 is connected to the input port 172b, the branch oil passage L11 is connected to the input port 172c, and the lockup oil passage L8 is connected to the output port 172d. When the signal pressure Pslu is not applied to the signal pressure input port 172a, the spool 174 of the lockup relay valve 170 of the modification is moved to the position shown in FIG. 8 to cut off communication between the input port 172b (control pressure oil passage L4) and the output port 172d (lockup oil passage L8) and to allow the input port 172c (branch oil passage L11) to communicate with the output port 172d. On the other hand, when the signal pressure Pslu that is larger than the biasing force of the spring 176 is applied to the signal pressure input port 172a, the spool 174 is moved to the position shown in FIG. 9 to allow the input port 172b (control pressure oil passage L4) to communicate with the output port 172d (lockup oil passage L8) and to cut off communication between the input port 172c (branch oil passage L11) and the output port 172d.

In the hydraulic control device 150 of the modification, the secondary pressure oil passage L2 is directly connected to the circulation input port 36a. Accordingly, the secondary pressure Psec is constantly applied to the converter oil chamber 31a. The lockup clutch 37 is disengaged by turning off the linear solenoid valve SLU to bring the spool 174 of the lockup relay valve 170 into the state shown in FIG. 8. In this state, since the branch oil passage L11 communicates with the lockup oil passage L8, part of the hydraulic oil having passed through the converter oil chamber 31a due to the secondary pressure Psec is supplied to the lockup oil chamber 39a via the branch oil passage L11 and the lockup oil passage L8. In this state, the lockup oil chamber 39a and the lockup oil passage L8 are therefore filled with the hydraulic oil. On the other hand, the lockup clutch 37 is engaged by turning on the linear solenoid valve SLU to bring the spool 174 of the lockup relay valve 170 into the state shown in FIG. 9 and controlling the lockup control valve 60 by adjusting the signal pressure Pslu to be output from the linear solenoid valve SLU so that the difference between the oil pressure in the lockup oil chamber 39a and the oil pressure in the converter oil chamber 31a becomes equal to a target oil pressure. In this state, since communication between the branch oil passage L11 and the lockup oil passage L8 is cut off, and the control pressure oil passage L4 communicates with the lockup oil passage L8, the control pressure Pcl output from the output port 62c of the lockup control valve 60 is supplied to the lockup oil chamber 39a as an engagement pressure via the control pressure oil passage L4 and the lockup oil passage L8. Since the secondary pressure Psec is applied to the converter oil chamber 31a as described above, the lockup clutch 37 can be engaged by controlling the lockup control valve 60 so that the control pressure Pcl becomes higher than the secondary pressure Psec. When the lockup clutch 37 is in the disengaged state, the lockup oil chamber 39a and the lockup oil passage L8 are filled with hydraulic oil. This allows the oil pressure in the lockup oil chamber 39a to rise quickly when the control pressure Pcl is applied to the lockup oil chamber 39a, whereby the lockup clutch 37 can be smoothly engaged.

Correspondence between the main elements of the embodiment and the main elements of the disclosure described in the section “SUMMARY” will be described below. In the embodiment, the converter oil chamber 31a corresponds to the “circulation oil chamber,” the lockup oil chamber 39a corresponds to the “engagement oil chamber,” and the lockup control valve 60 corresponds to the “pressure regulating valve.” The lockup relay valve 70 corresponds to the “switch.” The control pressure oil passage L4 corresponds to the “control pressure oil passage,” the circulation input oil passage L6 corresponds to the “circulation input oil passage,” the circulation output oil passage L7 corresponds to the “circulation output oil passage,” and the lockup oil passage L8 corresponds to the “engagement pressure oil passage.” Since the embodiment is shown by way of example in order to specifically describe the mode for carrying out the disclosure described in the section “SUMMARY,” the correspondence between the main elements of the embodiment and the main elements of the disclosure described in the section “SUMMARY” is not intended to limit the elements of the disclosure described in the section “SUMMARY.” For example, the linear solenoid SLT may be included in the “switch.” That is, the disclosure described in the section “SUMMARY” should be construed based on the description in the section “SUMMARY,” and the embodiment is merely a specific example of the disclosure described in the section “SUMMARY.”

Although the mode for carrying out the disclosure is described above by using the embodiment, it should be understood that the present disclosure is not limited in any respect to the embodiment and that the present disclosure can be carried out in various forms without departing from the spirit and scope of the present disclosure.

### INDUSTRIAL APPLICABILITY

The present disclosure is applicable to the manufacturing industry of hydraulic control devices.

1. A hydraulic control device for controlling an oil pressure to be supplied to and discharged from a hydraulic transmission device that has a circulation oil chamber having a circulation input port for receiving hydraulic oil and a circulation output port for outputting the hydraulic oil so that the hydraulic oil is circulated in the circulation oil chamber via the circulation input port and the circulation output port, and an engagement oil chamber having an engagement port for receiving and outputting the hydraulic oil, and that includes a lockup clutch that is engaged due to a difference between an oil pressure in the circulation oil chamber and an oil pressure in the engagement oil chamber, the hydraulic control device comprising:
a pressure regulating valve capable of regulating a source pressure to generate a control pressure higher than the oil pressure in the circulation oil chamber and supplying the control pressure to the engagement port, wherein
when disengaging the lockup clutch, the hydraulic oil is circulated in the circulation oil chamber via the circulation input port and the circulation output port, and part of the hydraulic oil circulated in the circulation oil chamber is supplied to the engagement port, and when engaging the lockup clutch, the supply of the hydraulic oil circulated in the circulation oil chamber to the engagement port is cut off, and the control pressure is supplied to the engagement port.

2. The hydraulic control device according to claim 1, further comprising:
a switch that switches between a first state where the hydraulic oil is circulated in the circulation oil chamber via the circulation input port and the circulation output port and part of the hydraulic oil circulated in the circulation oil chamber is supplied to the engagement port and a second state where the supply of the hydraulic oil circulated in the circulation oil chamber to the engagement port is cut off, wherein
when disengaging the lockup clutch, the switch is switched to the first state to cut off the supply of the control pressure from the pressure regulating valve to the engagement port, and when engaging the lockup clutch, the switch is switched to the second state to supply the control pressure from the pressure regulating valve to the engagement port.

3. The hydraulic control device according to claim 2, wherein
the switch supplies the hydraulic oil discharged from the circulation output port to the engagement port when in the first state.

4. The hydraulic control device according to claim 3, further comprising:
a control pressure oil passage connected to an output port of the pressure regulating valve;
a circulation input oil passage connected to the circulation input port;
a circulation output oil passage connected to the circulation output port;
a branch oil passage branching off from the circulation output oil passage; and
an engagement pressure oil passage connected to the engagement port, wherein
the switch allows the branch oil passage to communicate with the engagement pressure oil passage and cuts off communication between the control pressure oil passage and the engagement pressure oil passage when in the first state, and cuts off the communication between the branch oil passage and the engagement pressure oil passage and allows the control pressure oil passage to communicate with the engagement pressure oil passage when in the second state.

5. A hydraulic control method for controlling an oil pressure to be supplied to and discharged from a hydraulic transmission device that has a circulation oil chamber having a circulation input port for receiving hydraulic oil and a circulation output port for outputting the hydraulic oil so that the hydraulic oil is circulated in the circulation oil chamber via the circulation input port and the circulation output port, and an engagement oil chamber having an engagement port for receiving and outputting the hydraulic oil, and that includes a lockup clutch that is engaged due to a difference between an oil pressure in the circulation oil chamber and an oil pressure in the engagement oil chamber, the hydraulic control method comprising:
when disengaging the lockup clutch, circulating the hydraulic oil in the circulation oil chamber via the circulation input port and the circulation output port and supplying part of the hydraulic oil circulated in the circulation oil chamber to the engagement port, and when engaging the lockup clutch, cutting off the supply of the hydraulic oil circulated in the circulation oil chamber to the engagement port and supplying a control pressure higher than the oil pressure in the circulation oil chamber to the engagement port.
